(19) United States
(12) Patent Application Publication
(10) Pub. No.: US 2026/0119530 A1
(43) Pub. Date: Apr. 30, 2026

(54) Cluster Dimensioning For Scale-Out Distributed Object Storage

(71) Applicant: Rakuten Symphony, Inc., Tokyo (JP)

(72) Inventor: Nilesh Sitaram Somani, San Mateo, CA (US)

(21) Appl. No.: 18/927,636

(22) Filed: Oct. 25, 2024

(51) Int. Cl. G06F 16/28; G06F 16/22; G06F 16/25

(52) U.S. Cl. CPC G06F 16/285; G06F 16/2264; G06F 16/258

(57) ABSTRACT

A cluster may be dimensioned based on first input features defining data objects to be stored in the one or more data stores. One or more second input features may be calculated according to the first input features, the first input features and the second input features defining resource requirements of the data objects due to at least one of data storage format, replication, or parity data. Output features are calculated based on the first input features and the second input features, the output features defining the dimensioning of the cluster for the one or more data stores. A cluster may be provisioned and instantiated according to the dimensioning.

### BACKGROUND

### Field of the Invention

The present disclosure relates to cluster dimensioning for scale-out distributed object storage.

### Background of the Invention

The information disclosed in this background section is only for enhancement of understanding of the general background of the disclosure and should not be taken as an acknowledgement or any form of suggestion that this information forms the prior art already known to a person skilled in the art.

Cluster dimensioning in distributed storage deployments for a data store refers to the process of determining the appropriate size, configuration, and resources for a storage cluster to meet performance, capacity, and reliability requirements. It would be an advancement in the art to improve the process of dimensioning a cluster for a data store.

### SUMMARY OF THE INVENTION

In one aspect, a method is used for dimensioning a cluster for one or more data stores. The method includes: receiving, by a computer system, first input features defining data objects to be stored in the one or more data stores; calculating, by the computer system, second input features according to the first input features, the first input features and the second input features defining resource requirements of the data objects due to at least one of data storage format, replication, or parity data; and calculating, by the computer system, output features based on the first input features and the second input features, the output features defining the dimensioning of the cluster for the one or more data stores.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which containers may be deployed in accordance with an embodiment;

FIG. 2 is a process flow diagram of a method for performing cluster dimensioning in accordance with an embodiment; and

FIG. 3 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

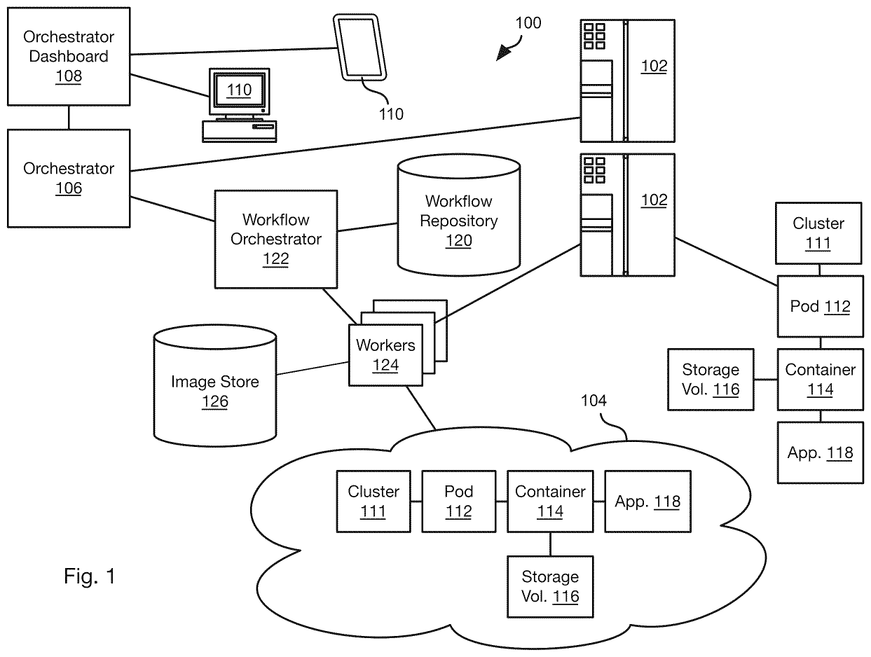

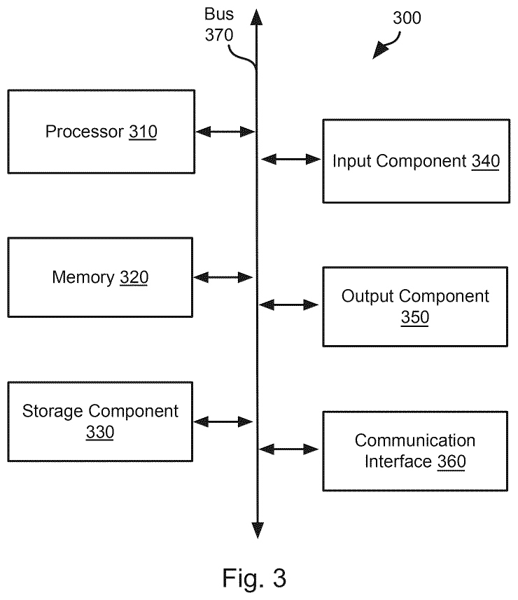

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102 (e.g., on-premise servers). Each of the servers 102 may include one or more computing devices, such as a computing device having some or all of the attributes of the computing device 300 of FIG. 3.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. Servers 102 that function as edge servers may have limited computational resources or may be heavily loaded.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118.

An orchestrator 106 may execute on a computer system that is distinct from the servers 102 and is connected to the servers 102 by a network that requires the use of a destination address for communication, such as using a networking including ethernet protocol, internet protocol (IP), Fiber Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

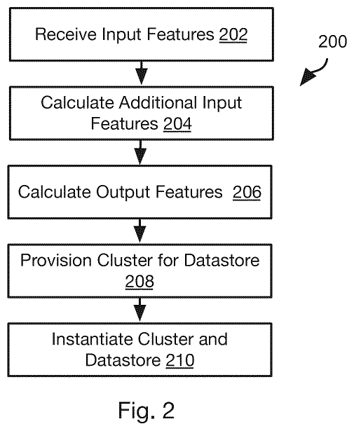

Referring to FIG. 2, a cluster 111 may function as a storage cluster. The dimensions of the storage cluster may be determined according to the illustrated method 200. Cluster dimensioning in distributed storage deployments refers to the process of determining the appropriate size, configuration, and resources for a storage cluster to meet performance, capacity, and reliability requirements. The most common problem that arises during dimensioning is the use of an incorrect hardware specifications requirement. An incorrect hardware specification requirement can result in underutilization of hardware or shortage of resources such as virtual central processing units (vCPU) and memory leading to poor performance. This leads to frequent dimensioning cycles, which in turn increases the risk of service failure and/or downtime, compounding incorrect dimensioning, and so on.

The method 200 provides an approach that processes a broad array of input features according to calculations described below in order to more accurately dimension a storage cluster and reduce or possibly eliminate additional dimensioning cycles. The method 200 may be executed by an orchestrator 106 or some other software component. The method 200 includes receiving 202 input features defining an object storage deployment. The input features may be received through an interface, such as a webpage, the orchestrator dashboard 108, graphical user interface (GUI) to an application implementing the method 200, or other interface. The input features may be used to calculate 204 one or more additional input features. In the following description “input features” may be understood as including the input features received at step 202 and the input features calculated at step 204.

The input features may be characterized as describing the size of objects to be stored in a data store, the format in which the objects are stored, replication and parity requirements, an architecture that is used to access objects in the data store (e.g., meta services), drives used (e.g., hard disk drives, solid state drives, virtual storage drives), nodes (e.g., physical computing devices or virtual machines) hosting the data store, memory allocated to the data store on nodes, processing resources allocated to the data store (e.g., central processing units (CPUs)), processor cores, or virtualized processing resources (vCPUs)), networking configuration data (e.g., number and resources of network gateways, drive throughput, and/or network bandwidth).

The input features may include some or all of the input features shown Table 1. Input features received at step 202 are labeled as “user input” with the remainder of features being those calculated at step 204. Specific values for an input feature listed in Table 1 are exemplary only and other values are also possible.

TABLE 1
Example input features in an object storage deployment

| Feature | Value | Description | Formula |
|---|---|---|---|
| K | User Input | Data blocks for an | N/A |
| | | object | |
| M | User Input | Parity blocks for an | N/A |
| | | object | |
| obj_size (object size) | User Input | Average object size | N/A |
| | | expected by the | |
| | | storage from the | |
| | | application/'s (In | |
| | | Bytes) | |
| chunk_size | Auto | Data block size | obj_size/K |
| | Calculated | after the sharding | |
| | | the input object into | |
| | | K chunks (In Bytes) | |
| stripe_size | Auto | Size of the object | chunk_size * |
| | Calculated | after performing | (K + M) |
| | | erasure coding | |
| mstores_per_cluster | User Input | There are different | N/A |
| (meta services per | | types of | |
| cluster) | | architecture for | |
| | | object storage. | |
| | | Some with central | |
| | | database (e.g., meta | |
| | | service) and some | |
| | | without central | |
| | | database. This | |
| | | variable represents | |
| | | how many such | |
| | | central meta | |
| | | services | |
| | | (“mstores”) are | |
| | | present in a | |
| | | deployment. | |
| mem_per_mstore | User Input | Memory to be | >=10 GB (typical |
| (memory per meta | | allocated for one | recommendations |
| service) | | such meta service | for DB servers) |
| vcpu_per_mstore | User Input | vCPUs to be | >=3 (typical |
| (vCPUs per meta | | allocated for one | recommendations |
| service) | | such meta service | for DB servers) |
| mstore_db_replication | User Input | Databases can have | N/A |
| (meta service database | | single or multiple | |
| replication) | | replicas as per user | |
| | | requirement for | |
| | | fault tolerance. | |
| db_drives_per_cluster | Auto | Number of drives to | mstores_per_cluster |
| (database drives per | Calculated | be used by mstores. | * |
| cluster) | | Can be located | mstore_db_replication |
| | | anywhere in the | |
| | | cluster | |
| tot_drives (total drives) | User Input | Total number of the | Value of tot_drives |
| | | drives in the cluster | should satisfy, |
| | | to consume | {(tot_drives − |
| | | | db_drives_per_cluster) % |
| | | | (K + M)} = 0 |
| tot_ds_drives | Auto | Total number of the | tot_drives − |
| (data store drives per | Calculated | drives in the cluster | db_drives_per_cluster |
| cluster) | | to be consumed for | |
| | | the actual data | |
| tot_nodes (total nodes) | User Input | Total number of the | Value of tot_nodes |
| | | nodes in the cluster | should satisfy, |
| | | to consume | tot_ds_drives % |
| | | | tot_nodes = 0 |
| ds_drives_per_node | Auto | Number of drives | tot_ds_drives/ |
| (data store drives per | Calculated | per node to be | tot_nodes |
| node) | | consumed by data | |
| | | stores | |
| ds_drive_capacity (data | User Input | Capacity of each | N/A |
| store drive capacity) | | drive to be | |
| | | consumed by data | |
| | | store | |
| drive_throughput (data | User Input | OEM published | N/A |
| store drive throughput) | | throughput for the | |
| | | drive | |
| gateways_per_node | User Input | Gateway is the | >=1 (at least one |
| | with auto | endpoint with | endpoint is needed) |
| | Scalability | which object | |
| | | storage applications | |
| | | interact. Typically | |
| | | such services have | |
| | | minimum count and | |
| | | scale/descale as per | |
| | | load. | |
| mem_per_gateway | User Input | Gateways are | >=100 GB |
| (memory per gateway) | | dealing with | |
| | | complete object and | |
| | | object | |
| | | manipulations | |
| | | before sharding and | |
| | | sending to data | |
| | | stores. | |
| vcpu_per_gateway | User Input | Gateways are | >=12 |
| | | responsible for | |
| | | erasure coding, | |
| | | encryption, | |
| | | compression, | |
| | | checksum | |
| | | calculation. All of | |
| | | these are CPU | |
| | | intensive | |
| dstores_per_node (data | Auto | Each data service | dstores_per_node = |
| stores per node) | Calculated | typically manages | ds_drives_per_node |
| | | one raw disk | |
| mem_per_dstore | User Input | Data stores are | >=20 GB |
| (memory per datastore) | | responsible for | |
| | | holding the shards | |
| | | in-memory while | |
| | | writing to disks | |
| vcpu_per_dstore | User Input | Data stores are | >=4 |
| (vCPU per data store) | | responsible for | |
| | | detecting bitrot on | |
| | | shards which are | |
| | | CPU intensive | |
| | | operations. | |
| buffer_mem_per_node | User Input | This memory | buffer_mem_per_node >= |
| (buffer memory per | | comes handy when | mem_per_gateway + |
| node) | | gateways needs to | mem_per_mstore |
| | | be scaled up during | |
| | | higher load. Also | |
| | | there is a chance | |
| | | that meta store | |
| | | service will land on | |
| | | this node | |
| buffer_vcpu_per_node | User Input | These vCPUs | buffer_vcpu_per_node >= |
| (number of vCPUs per | | comes handy when | vcpu_per_gateway + |
| buffer per node) | | gateways needs to | vcpu_per_mstore |
| | | be scaled up during | |
| | | higher load. Also | |
| | | there is a chance | |
| | | that meta store | |
| | | service will land on | |
| | | this node | |
| network_bandwidth | User Input | The maximum | N/A |
| | | bandwidth between | |
| | | the nodes | |

The method 200 may include calculating 206 output features based on the input features. The output features may include aggregate values of resources to be allocated to the data store based on the input features. In particular, the output features are obtained by executing calculations with respect to the input features to more accurately determine resources required to implement the data store. For example, the number of nodes may be a user-specified value and the output features may specify memory resources and processing resources required for each node. For example, the output features may be a combination (e.g., sum) of memory requirements per node for some or all of one or more data stores on the node, one or more gateways on the node, and one or more buffers on the node. The output features may be a combination (e.g., sum) of processing (e.g., vCPU) requirements per node for some or all of one or more data stores on the node, one or more gateways on the node, and one or more buffers on the node. Storage resources may be specified by a user or may also be calculated as an output feature.

Calculating the output features may additionally include calculating expected performance values for the data store based on the aggregate values of resources, such as storage capacity, input/output capacity (e.g., PUTs and GETs), and/or throughput. In this manner, a user may assess whether the expected performance is inadequate or excessive and adjust the user-supplied input features to increase or decrease performance.

The output features may include some or all of the output features listed in Table 2.

TABLE 2
Output features

| Feature | Description | Formula |
|---|---|---|
| mem_per_node (memory | Memory requirement per | (gateways_per_node * |
| per node) | node | mem_per_gateway) + |
| | | (dstores_per_node + |
| | | mem_per_dstore) + |
| | | buffer_mem_per_node |
| cpu_per_node | vCPU requirement per | (gateways_per_node * |
| | node | vcpu_per_gateway) + |
| | | (dstores_per_node * |
| | | vcpu_per_dstore) + |
| | | buffer_vcpu_per_node |
| dstore_capability (data | Simultaneous PUTs/GETs | min |
| store capability) | | {(mem_per_dstore/chunk_size) |
| | | * [(tot_drives − |
| | | db_drives_per_cluster)/(K + M)], |
| | | network_bandwidth/ |
| | | chunk_size, |
| | | (drive_throughput * |
| | | [(tot_drives − |
| | | db_drives_per_cluster)/(K + M)])/ |
| | | chunk_size} |
| gateway_capability | Simultaneous PUTs/GETs | min { |
| | | (mem_per_gateway/obj_size) |
| | | * gateways_per_node * |
| | | tot_nodes, |
| | | network_bandwidth/ |
| | | obj_size} |
| cluster_raw_capacity | The raw capacity available | ds_drives_per_node * |
| | to be consumed by the | tot_nodes * |
| | cluster | ds_drive_capacity |
| cluster_usable_capacity | The capacity available for | cluster_raw_capacity * (K/ |
| | usage | (K + M)) |
| no_of_erasure_sets | Total number of erasure | (ds_drives_per_node * |
| (number of erasure sets) | sets that will be created | tot_nodes)/(K + M) |
| | with K + M config | |
| disk_failure_tolerance | Number of disk failure that | M disks |
| | can be tolerated per erasure | |
| | set | |
| node_failure_tolerance | Number of node failure | [(tot_nodes * M)/(K + M)] + |
| | than can be tolerated in the | {[(tot_nodes % (K + M)) − |
| | cluster | 1]/M} |
| Cluster IOPs (cluster | Simultaneous PUTs/GETs | min(gateway_capability, |
| input output operations) | | dstore_capability) |
| Cluster BW (cluster | Total throughput | Cluster IOPs * obj_size |
| bandwidth) | | |

The output features may be output to the user, such as using the same interface from which input features were received at step 202. The user may then manually provision a cluster 111 that is dimensioned according to the output features. In some embodiments, the method 200 may include provisioning 208 a cluster for the data store. For example, the orchestrator 106 may invoke provisioning of a cluster 111 having the dimensions included in the input and output features, e.g., the number of drives, the amount of memory, and the amount of processing resources (e.g., vCPUs). The orchestrator 106 may further invoke instantiating 210 a cluster and the data store on the resources provisioned at step 208, such as by instantiating a cluster 111 in a network environment having some or all of the attributes of the network environment 100.

FIG. 3 illustrates an embodiment of a computing device 300. As shown in FIG. 3, the device 300 processor 310, a memory 320, a storage component 330, an input component 340, an output component 350, a communication interface 360, and a bus 370.

The processor 310, as used herein, means any type of computational circuit that may comprise hardware elements and software elements. The processor 310 may be embodied as a multi-core processor, a single core processor, or a combination of one or more multi-core processors and/or one or more single core processors, a distributed processing system, or the like. The processor 310 may be a Central Processing Unit (CPU) a graphics processing unit (GPU), an accelerated processing unit (APU), an application-specific integrated circuit (ASIC), or another type of processing component.

Memory 320 includes a non-transitory computer readable medium. Memory 320 includes a random-access memory (RAM), a read only memory (ROM), and/or another type of dynamic or static storage device (e.g., a flash memory, a magnetic memory, and/or an optical memory) that stores information and/or instructions for use by processor 310. The memory 320 comprises machine-readable instructions which are executable by the processor 310. These machine-readable instructions when executed by the processor 310 cause the processor 310 to perform one or more method steps of an embodiment described above.

Storage component 330 stores information and/or software related to the operation and use of the device 300. For example, storage component 330 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 340 is configured to receive information, such as user input. For example, the input component 340 may include, but not be limited to, a touch screen display, a keyboard, a keypad, a mouse, a button, a switch, and/or a microphone. Additionally, or alternatively, the input component 340 may include a sensor for sensing information (e.g., a global positioning system (GPS), an accelerometer, a gyroscope, and/or an actuator).

Output component 350 is configured to provide output information from the device 300. For example, the output component 350 may be, but not limited to, a display, a speaker, instructions to an external device, and/or one or more light-emitting diodes (LEDs).

Communication interface 360 is an interface that provides a communication connection to other devices, such as external devices and internal devices. The connection by the communication interface 360 can be a wired connection, a wireless connection, or a combination of wired and wireless connections, and can be a direct connection or an indirect connection via a communication network that exists between the device 300 and other devices. In other words, the standard of the communication interface 360 is not limited.

The bus 370 acts as an interconnect between the processor 310, the memory 320, the storage component 330, the input component 340, the output component 350, and the communication interface 360 of the device 300. The bus 370 may include a wired interconnection or a wireless interconnection.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300. Further, one or more method steps described in any of the embodiments may be performed utilizing a plurality of devices 300 in communication with one another.

In a first example embodiment, a method for dimensioning a cluster for one or more data stores includes: receiving, by a computer system, first input features defining data objects to be stored in the one or more data stores; calculating, by the computer system, second input features according to the first input features, the first input features and the second input features defining at least one of a data storage format, a replication requirement, or a parity requirement; and calculating, by the computer system, output features based on the first input features and the second input features, the output features defining the dimensioning of the cluster for the one or more data stores.

In a second example embodiment of the first example embodiment, the output features define memory requirements.

In a third example embodiment of the first example embodiment, the output features define processing requirements.

In a fourth example embodiment of the third example embodiment, the output features define a virtual central processing unit (vCPU) requirement.

In a fifth example embodiment of the first example embodiment, the first input features define the data storage format, the data storage format including at least one of: a size of each data object of the data objects; a number of data blocks per data object of the data objects; and a number of parity blocks for an object.

In a sixth example embodiment of the fifth example embodiment, the second input features include at least one of: a chunk size of each data block; and a stripe size of each object of the data objects following erasure coding.

In a seventh example embodiment of the first example embodiment, the first input features include a number of meta stores for the one or more data stores, an amount of memory per meta store, and an amount of processing resources per meta store.

In an eight example embodiment of the first example embodiment, the first input features include a number of gateways per node, an amount of memory per gateway, a drive throughput, and a network bandwidth.

In a ninth example embodiment of the first example embodiment, the first input features include an amount of buffer memory per node and an amount of processing resources per node for buffering.

In a tenth example embodiment of the first example embodiment, the output features include an aggregation of per node memory requirements of: the one or more data stores; buffers; and gateways.

In an eleventh example embodiment of the first example embodiment, the output features include an aggregation of per node processing requirements of; the one or more data stores; buffers; and gateways.

In a twelfth example embodiment of the eleventh example embodiment, the per node processing requirements include a number of virtual central processing units (vCPU).

In a thirteenth example embodiment of the first example embodiment, the output features include estimated performance of the cluster.

In a fourteenth example embodiment of the thirteenth example embodiment, the estimated performance includes an estimated number of simultaneous PUTs and GETs of the cluster.

In a fifteenth example embodiment of the thirteenth example embodiment, the estimated performance includes a node failure tolerance.

In a sixteenth example embodiment of the thirteenth example embodiment, the estimated performance includes a disk failure tolerance.

In a seventeenth example embodiment of the thirteenth example embodiment, the estimated performance includes an a throughput of the cluster.

In an eighteenth example embodiment of the first example embodiment, the first input features and the second input features include Table 1.

In a nineteenth example embodiment of the first example embodiment, the output features include Table 2.

In a twentieth example embodiment, a non-transitory computer readable medium storing executable code that, when executed by one or more processing devices, causes the one or more processing devices to: receive first input features defining data objects to be stored in one or more data stores; calculate second input features according to the first input features, the first input features and the second input features defining at least one of a data storage format, a replication requirement, or a parity requirement; calculate output features based on the first input features and the second input features, the output features defining dimensioning of a cluster to execute the one or more data stores; and provision and instantiate the cluster according to the dimensioning in a network environment.

1. A method for dimensioning a cluster for one or more data stores comprising:
receiving, by a computer system, first input features defining data objects to be stored in the one or more data stores;
calculating, by the computer system, second input features according to the first input features, the first input features and the second input features defining at least one of a data storage format, a replication requirement, or a parity requirement; and
calculating, by the computer system, output features based on the first input features and the second input features, the output features defining dimensioning of the cluster for the one or more data stores;
provisioning and instantiating, by the computer system, a cluster in a network environment according to the dimensioning of the cluster; and
storing, by the computer system, the data objects in the cluster.

2. The method of claim 1, wherein the output features define memory requirements.

3. The method of claim 1, wherein the output features define processing requirements.

4. The method of claim 3, wherein the output features define a virtual central processing unit (vCPU) requirement.

5. The method of claim 1, wherein the first input features define the data storage format, the data storage format including at least one of:
a size of each data object of the data objects;
a number of data blocks per data object of the data objects; and
a number of parity blocks for an object.

6. The method of claim 5, wherein the second input features include at least one of:
a chunk size of each data block; and
a stripe size of each object of the data objects following erasure coding.

7. The method of claim 1, wherein the first input features include a number of meta stores for the one or more data stores, an amount of memory per meta store, and an amount of processing resources per meta store.

8. The method of claim 1, wherein the first input features include a number of gateways per node, an amount of memory per gateway, a drive throughput, and a network bandwidth.

9. The method of claim 1, wherein the first input features include an amount of buffer memory per node and an amount of processing resources per node for buffering.

10. The method of claim 1, wherein the output features include an aggregation of per node memory requirements of:
the one or more data stores;
buffers; and
gateways.

11. The method of claim 1, wherein the output features include an aggregation of per node processing requirements of;
the one or more data stores;
buffers; and
gateways.

12. The method of claim 11, wherein the per node processing requirements include a number of virtual central processing units (vCPU).

13. The method of claim 1, wherein the output features include estimated performance of the cluster.

14. The method of claim 13, wherein the estimated performance includes an estimated number of simultaneous PUTs and GETs of the cluster.

15. The method of claim 13, wherein the estimated performance includes a node failure tolerance.

16. The method of claim 13, wherein the estimated performance includes a disk failure tolerance.

17. The method of claim 13, wherein the estimated performance includes a throughput of the cluster.

18. The method of claim 1, wherein the first input features and the second input features include Table 1.

19. The method of claim 1, wherein the output features include Table 2.

20. A non-transitory computer readable medium storing executable code that, when executed by one or more processing devices, causes the one or more processing devices to:
receive first input features defining data objects to be stored in one or more data stores;
calculate second input features according to the first input features, the first input features and the second input features defining at least one of a data storage format, a replication requirement, or a parity requirement;
calculate output features based on the first input features and the second input features, the output features defining dimensioning of a cluster to execute the one or more data stores; and
provision and instantiate the cluster according to the dimensioning in a network environment.
